(19) United States
(12) Patent Application Publication
(10) Pub. No.: US 2026/0347957 A1
(43) Pub. Date: Nov. 5, 2026

(54) METHOD AND SYSTEM FOR CONTROLLING A PLANT SECTION OF A SUGAR PRODUCTION PLANT, SUGAR PRODUCTION PLANT AND COMPUTER PROGRAM

(71) Applicant: PFEIFER & LANGEN IP GMBH, Köln (DE)

(72) Inventors: Andreas SOIKA, Köln (DE); Marten VÖLKER, Köln (DE); Helena STRY JEWSKA, Köln (DE); Artur KNAUS, Köln (DE); Wolfgang KLOSTER HALFEN, Köln (DE)

(21) Appl. No.: 19/488,204

(22) PCT Filed: May 29, 2024
(86) PCT No.: PCT/EP2024/064809

§ 371 Date: Nov. 26, 2025

(30) Foreign Application Priority Data
Jun. 1, 2023 (EP) 23176848.2

(51) Int. Cl. C13B 30/02; G05B 13/04

(52) U.S. Cl. CPC C13B 30/025; C13B 30/028; G05B 13/048

(57) ABSTRACT

The present invention concerns a method for controlling a plant section of a sugar production plant comprising a common feed tank and multiple crystallisers and one more strike receivers and one or more centrifuges, wherein the multiple crystallisers are configured for receiving feed syrup from the common feed tank and crystallising sugar in a semi-batch process in order to obtain massecuite, wherein the one or more strike receivers are configured for receiving massecuite discharged from one or more of the crystallisers and to feed the massecuite to one or more of the centrifuges, wherein the centrifuges are configured for receiving the massecuite and separating syrup from sugar crystals in a batch process, wherein the method includes the following method steps executed by a control unit, in particular a model predictive control unit: c) determining a thick juice mass flow rate to the feed tank (Ftj) and a feed syrup mass flow rate from the feed tank to all crystallisers (Fcrys,sm) and a massecuite mass flow rate to all centrifuges (Fcf, sm) using a continuous substitution model of the plant section, d) controlling the common feed tank and the multiple crystallisers and the one or more centrifuges depending on the determined thick juice mass flow rate to the feed tank (Ftj) and the determined feed syrup mass flow rate from the feed tank to all crystallisers (Fcrys,sm) and the determined massecuite mass flow rate to all centrifuges (Fcf, sm).

### FIELD OF THE INVENTION

The present invention concerns a method for controlling a plant section of a sugar production plant comprising a common feed tank and multiple crystallisers and one or more strike receivers and one or more centrifuges. The present invention further concerns a control unit, in particular a model predictive control unit, for controlling a plant section of a sugar production plant comprising a common feed tank and multiple crystallisers and one or more strike receivers and one or more centrifuges. Further subjects of the invention are a sugar production plant and a computer program.

### BACKGROUND OF THE INVENTION

Industrial sugar production plants typically comprise a plant section, also known as the sugar house, in which syrup is crystallised to obtain massecuite and sugar crystals are separated from the massecuite by centrifugation. Those plant sections typically comprise a common feed tank which receives syrup from an upstream evaporation section. The common feed tank is typically connected to multiple crystallisers which are configured for receiving feed syrup from the common feed tank and crystallising sugar in a semi-batch process in order to obtain massecuite. After completion of this semi-batch process, each crystalliser discharges its massecuite to one of one or more strike receivers. Those strike receivers buffer massecuite before it is fed to one of several centrifuges. The centrifuges are configured for receiving the massecuite and for separating syrup from sugar crystals in a batch process.

Control of the crystallisation and centrifugation processes, in particular starting and stopping the crystallisers and centrifuges, is typically carried out manually by experienced operators of the sugar plant. This, however, often leads to inefficient operation of the plant in terms of energy consumption. To elucidate this, attention is drawn to the operation of the crystallisers which is a semi-batch process. After filling the crystalliser with syrup from the common feed tank, evaporation is started by introducing heat and lowering the pressure inside the crystalliser. Seed magma is fed into the crystalliser and evaporation is continued in order to allow crystal growth. During evaporation, additional syrup is fed into the crystalliser from the common feed tank. When a desired dry substance content is reached, the evaporation process can in general be stopped. This is however, not possible if the strike receiver connected to the crystalliser is still filled up to a certain level. In such situations, where discharging from the crystalliser is not possible immediately after reaching the desired dry substance content, the crystalliser is operated in a so-called hold operation. In this hold operation the crystalliser continues evaporation by introducing heat while additional water is fed to the crystalliser to compensate for the evaporated water. The hold operation is highly energy inefficient.

US 2009/0204246 A1 discloses a method that includes determining how to adjust one or more manipulated variables using at least one model. The one or more manipulated variables are associated with a sugar dryer. The method also includes generating one or more control signals to control one or more controlled variables associated with the sugar dryer. The one or more controlled variables include an outfall temperature associated with the sugar dryer, and the one or more manipulated variables include a rate at which wet material is provided to the sugar dryer. The sugar dryer could include multiple sugar dryers. At least two of the sugar dryers could operate using different fuels. The one or more control signals could be generated to control the rates at which the wet material is provided to the multiple sugar dryers based on costs associated with the different fuels.

### SUMMARY OF THE INVENTION

In light of the above considerations, it is an object of the present invention to improve the energy efficiency of a sugar production plant.

The invention proposes a method for controlling a plant section of a sugar production plant comprising a common feed tank and multiple crystallisers and one or more strike receivers and one or more centrifuges,
wherein the multiple crystallisers are configured for receiving feed syrup from the common feed tank and crystallising sugar in a semi-batch process in order to obtain massecuite,
wherein the one or more strike receivers are configured for receiving massecuite discharged from one or more of the crystallisers and to feed the massecuite to one or more of the centrifuges,
wherein the centrifuges are configured for receiving the massecuite and separating syrup from sugar crystals in a batch process,
wherein the method includes the following method steps executed by a control unit, in particular a model predictive control unit:
a) determining a thick juice mass flow rate to the feed tank (Ftj) and a feed syrup mass flow rate from the feed tank to all crystallisers (Fcrys,sm) and a massecuite mass flow rate to all centrifuges (Fcf, sm) using a continuous substitution model of the plant section,
b) controlling the common feed tank and the multiple crystallisers and the one or more centrifuges depending on the determined thick juice mass flow rate to the feed tank (Ftj) and the determined feed syrup mass flow rate from the feed tank to all crystallisers (Fcrys,sm) and the determined massecuite mass flow rate to all centrifuges (Fcf, sm).

The inventive method allows to reduce or even avoid hold operation of the crystallisers in which water is added to the crystallisers while evaporation is continuing. Thus, waste of water and heating energy can be avoided and the crystallisers can be operated with improved energy efficiency. The inventive method achieves this effect by controlling the crystallisers, in particular controlling the activation of the crystallisers and/or by controlling the centrifuges, in particular the activation of the centrifuges. The common feed tank is controlled accordingly to allow for a smooth production process. Controlling the common feed tank, the crystallisers and the one or more centrifuges is based on a continuous substitution model of the plant section which is actually a semi-batch process. The continuous substitution model uses mass flow rates as main variables. Those mass flow rates may be determined using established mathematical methods and, in particular a model predictive control unit.

Within this application the term “mass flow rate” is used to indicate the mass of a substance which passes per unit of time. However, the mass flow rates can also be termed mass flux or mass current.

Within this application the term “continuous substitution model” defines a mathematical model used to simulate the behavior of the plant section, wherein the model uses mass flow rates as main variables and all mass flows are assumed to be continuous with linear dynamics. This allows the system to be efficiently controlled with LP-based model predictive control.

According to a preferred embodiment of the invention, method step b) includes controlling starting times of the multiple crystallisers and the one or more centrifuges. By controlling the starting time of the multiple crystallisers, the operation of the crystallisers can be aligned to avoid hold operation of the crystallisers. Controlling the starting times of the centrifuges can also contribute to a smooth process flow and avoid unwanted hold operation of the crystallisers.

According to a preferred embodiment of the invention, method step b) includes controlling an influx to the common feed tank. By controlling the influx to the common feed tank, the amount of syrup processed in the plant section can be influenced.

According to a preferred embodiment of the invention, the method further includes determining a feed tank mass in the common feed tank, wherein method step a) includes obtaining the respective flow rates depending on the determined feed tank mass. Determining the feed tank mass is preferably carried out indirectly. For example, a fill level in the feed tank may be measured using a fill level sensor and the feed tank mass may be calculated depending on the measured fill level in the feed tank. The calculation may further depend on a predetermined density of the syrup introduced into the common feed tank. The feed tank mass may be the total mass of the syrup or the dry mass of the syrup. The dry mass of the syrup equals the total mass multiplied by the dry substance content.

According to a preferred embodiment of the invention, the method further includes determining an aggregate mass in all of the strike receivers, wherein method step b) includes obtaining the respective flow rates depending on the determined aggregate mass in all of the strike receivers. Determining the aggregate mass in all of the strike receivers is preferably carried out indirectly. For example, a fill level in all of the strike receivers may be measured using respective fill level sensors and the aggregate mass may be calculated depending on the measured fill levels in all of the strike receivers. The calculation may further depend on a predetermined density of the massecuite introduced into the strike receivers. The aggregate mass may be the total mass of the massecuite or the dry mass of the massecuite. The dry mass of the massecuite equals the total mass multiplied by the dry substance content.

According to a preferred embodiment of the invention, the multiple crystallisers are configured as evaporating crystallisers, in particular vacuum pans, or as cooling crystallisers. The multiple crystallisers each allow crystallising in a batch process or a semi-batch process, which may include one or more of the following crystallising steps: a filling step, in which the crystalliser is filled with syrup from the common feed tank; a thickening step wherein the content of the crystalliser is thickened by evaporating the contained water while further feed syrup is introduced from the common feed tank; a seeding step, in which seed magma is introduced into the crystalliser without feeding further feed syrup; a evaporating step in which crystal growth is pro-moted by evaporating and simultaneously introducing feed syrup from the common feed tank until a predetermined dry substance content is reached; a tightening step in which the dry substance content is increase by evaporating without introducing further feed syrup; a discharging step in which the massecuite is discharged from the crystalliser; and a cleaning step in which hot steam is pushed into the crystalliser to remove residues of adhering massecuite.

According to a preferred embodiment of the invention, the common feed tank and the multiple crystallisers and the one or more strike receivers and the one or more centrifuges form a first production line, wherein the plant section additionally includes a second production line comprising a common feed tank and multiple crystallisers and one more strike receivers and one or more centrifuges, wherein the syrup obtained in the centrifuges is fed back to the common feed tank of the second production line. During centrifugation, the syrup of the massecuite is separated from the sugar crystals and directed to the common feed tank of the second sugar production line.

According to a preferred embodiment of the invention, the control unit determines boundary conditions for step a) depending on a predetermined number of active crystallisers. Those boundary conditions may limit the mass flow rates determined in step a) of the inventive method. For example, a maximum feed syrup mass flow rate from the feed tank to all crystallisers may be determined depending on the number of active crystallisers.

According to a preferred embodiment of the invention, the control unit determines boundary conditions for step a) depending on a predetermined number of active centrifuges. Those boundary conditions may limit the mass flow rates determined in step a) of the inventive method.

According to a preferred embodiment of the invention, the plant section additionally includes at least one seed crystalliser configured for receiving feed syrup from the common feed tank and a seed tank configured to receive seed massecuite from the seed crystallizer and for providing the seed magma to the multiple crystallisers. The seed magma may be introduced into the multiple crystallisers during a seed step as mentioned above.

According to a preferred embodiment of the invention, step a) further includes determining a feed syrup mass flow rate from the feed tank to the seed crystalliser and a seed magma flow to the multiple crystallisers using the continuous substitution model of the plant section.

According to a preferred embodiment of the invention, the method further includes determining a seed tank mass in the seed tank, wherein method step a) includes obtaining the respective flow rates depending on the determined seed tank mass. Determining the seed tank mass is preferably carried out indirectly. For example, a fill level in the seed tank may be measured using a fill level sensor and the seed tank mass may be calculated depending on the measured fill level in the seed tank. The calculation may further depend on a predetermined density of the seed magma introduced into the seed tank. The seed tank mass may be the total mass of the seed magma or the dry mass of the seed magma. The dry mass of the seed magma equals the total mass multiplied by the dry substance content.

According to a preferred embodiment of the invention, the common feed tank and the multiple crystallisers and the one or more strike receivers and the one or more centrifuges form a first production line, wherein the plant section additionally includes a second production line comprising a common feed tank and multiple crystallisers and one more strike receivers and one or more centrifuges, wherein the syrup obtained in the centrifuges of the first production line is fed back to the common feed tank of the second production line. Such embodiment allows producing sugar on multiple production lines in parallel, in particular producing different quali-ties of sugar in multiple lines in parallel. While a first line may produce sugar with higher purity a second line may produce sugar with lower purity.

The invention further proposes a control unit, in particular a model predictive control unit, for controlling a plant section of a sugar production plant comprising a common feed tank and multiple crystallisers and one or more strike receivers and one or more centrifuges,
wherein the multiple crystallisers are configured for receiving feed syrup from the common feed tank and crystallising sugar in a semi-batch process in order to obtain massecuite,
wherein the one or more strike receivers are configured for receiving massecuite discharged from one or more of the crystallisers and to feed the massecuite to one or more of the centrifuges,
wherein the centrifuges are configured for receiving the massecuite and separating syrup from sugar crystals in a batch process,
wherein the control unit is configured for executing the following method steps:
a) determining a thick juice mass flow rate to the feed tank (Ftj) and a feed syrup mass flow rate from the feed tank to all crystallisers (Fcrys, sm) and a massecuite mass flow rate to all centrifuges (Fcf, sm) using a continuous substitution model of the plant section,
b) controlling the common feed tank and the multiple crystallisers and the one or more centrifuges depending on the determined thick juice mass flow rate to the feed tank (Ftj) and the determined feed syrup mass flow rate from the feed tank to all crystallisers (Fcrys, sm) and the determined massecuite mass flow rate to all centrifuges (Fcf, sm).

The invention further proposes a sugar production plant comprising a common feed tank and multiple crystallisers and one or more strike receivers and one or more centrifuges,
wherein the multiple crystallisers are configured for receiving feed syrup from the common feed tank and crystallising sugar in a semi-batch process in order to obtain massecuite,
wherein the one or more strike receivers are configured for receiving massecuite discharged from one or more of the crystallisers and to feed the massecuite to one or more of the centrifuges,
wherein the centrifuges are configured for receiving the massecuite and separating syrup from sugar crystals in a batch process,
further including a control unit as described above.

The disclosed control unit and the disclosed sugar production plant may achieve the same technical effects and benefits as the method according to the invention.

According to a preferred embodiment of the inventive sugar production plant, the common feed tank and the multiple crystallisers and the one more or strike receivers and the one or more centrifuges form a first production line, wherein the plant section additionally includes a second production line comprising a common feed tank and multiple crystallisers and one more strike receivers and one or more centrifuges, wherein the syrup obtained in the centrifuges of the first production line is fed back to the common feed tank of the second production line.

The invention further proposes a computer program comprising instructions which, when the computer program is executed by a computer or a control unit, cause the computer or the control unit to carry out the method steps of the inventive method as described above.

The inventive control unit and the inventive sugar production plant may, as such or in combi-nation, make use of the preferred embodiments and features described in conjunction with the inventive method.

These and other characteristics, features and advantages of the present invention will become apparent from the following detailed description, taken in conjunction with the accompanying drawing, which illustrates, by way of example, the principles of the invention. The description is given for the sake of example only, without limiting the scope of the invention. The reference figures quoted below refer to the attached drawing.

### BRIEF DESCRIPTION OF THE DRAWINGS

FIG. 1 shows an embodiment of a section of a sugar production plant also referred to as a sugar house in a schematic flow diagram.

FIG. 2 shows the general working principle of model predictive control (MPC).

FIG. 3 shows a flow diagram in order to describe the relationship between mass flow rates and other state variables of the section of a sugar production plant.

### DETAILED DESCRIPTION OF THE DRAWINGS

The present invention will be described with respect to particular embodiments and with reference to a certain drawing but the invention is not limited thereto but only by the claims. The drawing described is only schematic and is non-limiting.

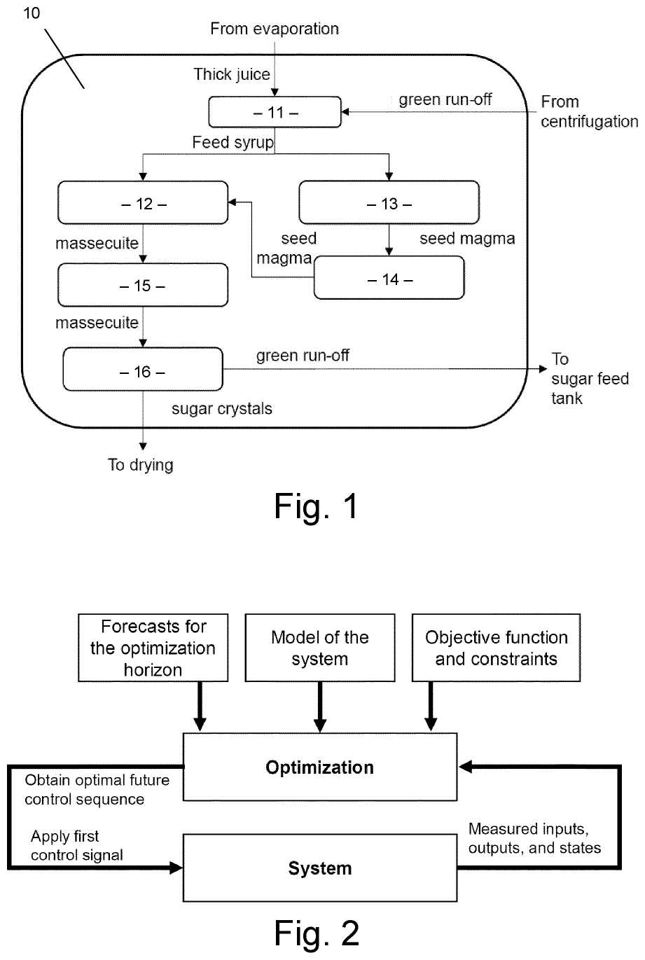

FIG. 1 shows a general flow diagram of an embodiment of a section 10 of a sugar production plant also referred to as the sugar house. This section 10 receives thick juice or syrup from an evaporation section of the sugar production plant arranged upstream the plant section 10. The syrup is buffered in a common feed tank 11 which includes a controllable outlet valve. The feed tank 11 is connected to multiple crystallisers 12 and to a single seed crystalliser 13. The seed crystallizer 13 discharges seed magma to a seed tank 14 which buffers the seed magma for the other crystallisers 12. Those crystallisers 12 each crystallise sugar in a semi-batch process. After end of a semi-batch process, the massecuite is discharged into one of multiple strike receivers 15, which serve as buffers for multiple centrifuges 16. In the centrifugation process, the syrup is separated from the sugar crystals. While the sugar crystals are discharged from the respective centrifuge 16 to a drying station, the syrup is either returned to a sugar feed tank of a parallel production line or to the common feed tank 11 of the same production line.

The plant section 10 incorporates an embodiment of an inventive control unit for controlling the plant section 11 in an energy efficient way. The control unit and the respective control method carried out by the control unit will be elucidated in the following. The plant section 10 may include one or more additional production lines which are not depicted in FIG. 1. If the plant section includes such additional production lines the control method may not control multiple, in particular all, production lines of the plant section 10.

The crystallizer scheduling problem of the plant section 10 is reformulated as part of a high-level optimal control problem (OCP), which is solved with model predictive control (MPC). The method to solve the optimal control problem can be chosen to be mixed integer linear programming (MILP), which is a commonly used method for production scheduling. Model predictive control is an established control strategy in process engineering to control continuous dynamical multiple input, multiple output (MIMO) systems, which are subject to constraints.

It uses an internal time-discrete dynamical model to compute future control steps based on the last control step, the systems current state and a model-based forecast. The general structure is shown in FIG. 2. At its core, the control is based on solving an optimization problem over a finite prediction horizon repeatedly. The definition of the overall objective is often driven by an economic standpoint. After obtaining an optimal control sequence, the first control signal is applied to the system and the systems reaction is measured. Afterwards, the forecast optimization is repeated. Since the prediction horizon for the model forecast has a fixed length, the forecast moves with every sampling time. Therefore, the optimization follows a receding horizon policy.

The goal is to minimize an objective function with multiple optimization variables. The objective function is subject to inequality and equality constraints. The objective function consists of the Mayer term for the terminal state cost and Lagrange term for the cost of each stage. A quadratic penalty on input changes can be tuned with a penalty matrix to smoothen the solution. Sequences for future model states, algebraic states and control inputs, which minimize the objective, are searched. The objective is subject to (non-) linear equality and inequality constraints, which impose the dynamical behavior of the system model as well as additional requirements, such as bounds on states and inputs. MPC is only capable of discrete optimization, so time-continuous models need to be discretized.

Different solvers exist that calculate the solutions of the OCP or optimization problems in general. The efficiency of the solving algorithm as well as applicability depends on the problem formulation. Of the solving methods compared in the following, linear programming (LP) is the fastest way of obtaining an optimal solution and is optimal for solving large problems with many variables and constraints. The objective function must be linear as well as all constraints to be solved with LP. This restriction often limits the ability to describe the dynamical behavior of a model precisely. MILP extends LP with the ability to define integer or binary decision variables to the continuous ones. This allows for a model which is more detailed as well as the repre-sentation of discrete decisions, such as if-else statements. Although it also scales well to big problems, the model complexity is higher than LP problems and a global optimum may not be found. If the objective or constraints of the problem formulation include nonlinear terms, the problem is considered as nonlinear programs (NLP) or mixed-integer nonlinear programs (MINLP). With MINLP, the dynamical model definition offers a high degree of freedom, but it does not scale well on big problems. To conclude this comparison, LP should be used, if possible, to reduce complexity of the model as well as computational effort. However, the model formulation restrictions are to be considered when describing the dynamics of the system.

Because optimization is a computational expensive process, time and efficiency are important aspects to consider for real-time scheduling. Therefore, a simplified substitution model is created with the goal to optimize the performance. It is modelled as a linear time-invariant system to achieve this. All mass flows are assumed to be continuous and linear, so that the system can be efficiently controlled with LP-based model predictive control.

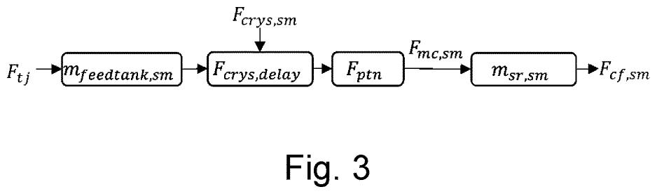

With reference to FIG. 3, the controlled variables of the continuous substitution model are the mass inside the feed tank m_{feedtank,sm} and the aggregated mass in the strike receivers m_{sr,sm}. The manipulated variables are the thick juice mass flow rate to the feed tank Ftj, the feed syrup mass flow rate from the feed tank to all crystallisers Fcrys,sm and the massecuite mass flow rate to all centrifuges Fcf,sm. The control scheme of the continuous substitution model is summarized in FIG. 3. To reach the goal of controlling the desired states m_{feedtank,sm} and m_{sr,sm}, the dead time of the crystallization process and delay caused by the discrete control of t_{A} require the intermediate states F_{crys,delay} and Fₚₜₙ. Here, tais a waiting time between consecutive crystalliser starts. F_{crys,delay} is a delayed F_{crys,sm} due to t_{A} and Fₚₜₙ is a dead time approximation for the massecuite flow to the strike receivers.

Based on sensor measurements at the feed tank 11 and the strike receivers 15, the feed tank mass m_{feedtank,sm} and the aggregated mass in all strike receivers m_{sr,sm} is determined. Those masses are controlled variables of the plant section 10. In order to control those variables, the control unit is configured for determining a thick juice mass flow rate to the feed tank Fₜⱼ and a feed syrup mass flow rate from the feed tank to all crystallisers F_{crys,sm} and a massecuite mass flow rate to all centrifuges F_{cf,sm} using the continuous substitution model of the plant section 10.

The model is simulated by providing an initial state and solving an initial value problem by the summation of the average flows at each timestep. Control inputs can be set at each iteration step of the simulation. As a result, the control unit controls the common feed tank and the multiple crystallisers and the one or more centrifuges depending on the determined thick juice mass flow rate to the feed tank Fₜⱼ and the determined feed syrup mass flow rate from the feed tank to all crystallisers F_{crys,sm} and the determined massecuite mass flow rate to all centrifuges F_{cf,sm}. For example, the control unit controls the influx to the common feed tank and the starting times of the crystallisers as well as the starting times of the centrifuges.

With further reference to FIG. 3, further explanations of the continuous substitution model will be provided in the following. The plant section is modelled as a linear time-invariant system. All mass flows are assumed to be continuous and linear, so that the system can be efficiently controlled with LP-based model predictive control.

The mass balance around the feed tank is calculated as follows, wherein green run-off is neglected:

$$\frac{d}{d t} {m}_{f e e d t a n k , s m} = {F}_{t j} - {F}_{c r y s}$$

m_{feedtank,sm}=Total mass in the feed tank [kg]

$${F}_{tj} = Thick juice mass flow rate to the feed tank [ \frac{k g}{min} ]$$

$${F}_{c r y s} = Mass flow of feed syrup to the crystallisers [ \frac{k g}{min} ]$$

The average mass flow of one crystallizer which is controlled by a waiting time between crystalliser starts t_{A} is defined with the following equation:

$${F}_{f}^{b a t c h} = {\sum }_{k ∈ K} \frac{{m}_{f}^{k}}{{n}_{c r y s} \cdot {t}_{A}} , {t}_{A} \geq \frac{{t}_{batch}}{{n}_{crys}}$$

$${F}_{b a t c h} = Mass flow of f of a {t}_{A} controlled batch [ \frac{kg}{min} ]$$

f ∈ {a2sl, a2seed, eval, mc}

$${m}_{f}^{k} = Mass of f for processing step k [ kg ]$$

K=Set of all processing steps [-]
n_{crys}=Number of crystallisers [-]
t_{batch}=Batch time of the fastest crystalliser [min]

To linearize the feed syrup flow to the crystallisers, it is multiplied by the number of crystallisers n_{crys}. The influence of the seed crystalliser can be included in the same fashion separately but is neglected in this case:

$${F}_{c r y s , s m} = \frac{{m}_{a 2 s l}^{b a t c h}}{{t}_{A}} , {t}_{A} \geq \frac{{t}_{batch}}{{n}_{crys}}$$

$${F}_{c r y s , s m} = Feed syrup flow to the crystallisers [ \frac{k g}{min} ]$$

n_{crys}=Number of standard crystallisers [-]

$${m}_{a 2 s l}^{b a t c h} = Mass of feed syrup for one crystallizer batch [ kg ]$$

t_{batch}=Batch time of the fastest crystalliser [min]

The batch duration t_{batch} is assumed to be constant over the simulation horizon. To calculate the feed syrup demand for one batch

$${m}_{a 2 sl}^{b a t c h}$$

the feed syrup flows of every batch processing step (filling, thickening, cooking) are summarized by:

$${m}_{a 2 s l}^{b a t c h} = {m}_{a 2 s l}^{fill} + {m}_{a 2 s l}^{t h i c k e n} + {m}_{a 2 s l}^{c o o k i n g} = Δ {m}_{crys , max} \cdot \frac{{α}_{c r y s , c o o k} \cdot {b}_{c o o k} - {α}_{c r y s , s e e d} \cdot {b}_{s e e d}}{{b}_{feed}}$$

a_{crys,cook}=Proportion of the mass inside a crystalliser after cooking to its maximum capacity [%]
a_{crys,seed}=Proportion of seed magma added to the crystalliser during seeding to its maximum capacity [%]
b_{cook}=Dry substance content after cooking [%]
b_{feed}=Dry substance content of feed syrup [%]
b_{seed}=Dry substance content of seed magma [%]

Since the model works with average flows, the maximum crystalliser capacity is also set as the average capacity Δm_{crys,max} as shown in the following equation.

$$Δ {m}_{crys , max} = \frac{1}{{n}_{c r y s}} \cdot {\sum }_{i ∈ I} {m}_{crys , max}^{i}$$

Δm_{crys,max}=Average maximum crystalliser capacity [kg]
I=Set of all standard crystallisers [-]

In reality, F_{crys,sm} is dependent on the starting interval of crystallisers and a change of t_{A} only changes the average flow with a delay. Therefore, an intermediate state F_{crys,delay} is introduced. The delay is approximated with a PT1 transfer function, which is defined as:

$$\frac{d}{d t} {F}_{c r y s , d e l a y} = \frac{{F}_{c r y s , s m} - {F}_{c r y s , d e l a y}}{{t}_{A}}$$

$${F}_{crys , delay} = delayed {F}_{c r y s , s m} [ \frac{k g}{min} ]$$

The strike receivers are summarized as one tank because of their connection at the bottom. The mass flows around the strike receivers only consist of the inflow from the crystallisers F_{mc,sm} and the outflow to the centrifuges F_{cf,sm}:

$$\frac{d}{d t} {m}_{s r , s m} = {F}_{m c , s m} - {F}_{cf , sm}$$

$${F}_{m c , s m} = Massecuite flow from crystallisers [ \frac{k g}{min} ]$$

$${F}_{c f , s m} = Massecuite flow to the centrifuges [ \frac{k g}{min} ]$$

Because the outflow F_{mc,sm} depends on the inflow F_{crys,delay}, but is delayed by the batch duration thatch, this dead time needs to be accounted for. Their dependence is modelled with a PT-N transfer function element Fₚₜₙ. Fₚₜₙ is defined as a vector that holds a series of n^{PTN} PT1 elements. The dynamics of this vector are shown in the following equation:

$$\frac{d}{d t} {F}_{p t n}^{i} = \{ \begin{matrix}\frac{{F}_{crys , delay} - {F}_{ptn}^{0}}{{T}_{D}} , i = 0 , i ∈ 0 , … , {n}_{ptn} \\ \frac{{F}_{ptn}^{i - 1} - {F}_{ptn}^{i}}{{T}_{D}} , i > 0 , {T}_{D} = \frac{{t}_{batch}}{{n}_{ptn}}\end{matrix}$$

i=Index of the PT-N element [-]
TD=Dead time of the PT1 element [min]
nₚₜₙ=Size of the PT-N vector [-]

The last element of the Fₚₜₙ vector is used to connect F_{mc,sm} to F_{crys,sm}, as it approximates the time delayed value of F_{crys,sm} best. It can be formulated as:

$${F}_{m c , s m} = Δ {m}_{crys , max} \cdot \frac{{α}_{c r ys , cook} \cdot {b}_{c o o k}}{{b}_{t i g h t} \cdot {t}_{A}} \cdot \frac{{F}_{p t n}^{{n}_{P T N}}}{{F}_{p t n}^{{n}_{P T N}}} ⇔ {F}_{m c , s m} = \frac{{α}_{c r ys , cook} \cdot {b}_{c o o k} \cdot {b}_{f e e d}}{{b}_{t i g h t} \cdot ( {α}_{c r ys , cook} \cdot {b}_{c o o k} - {α}_{c r ys , seed} \cdot {b}_{s e e d} )} \cdot {F}_{p t n}^{{n}_{P T N}} ,$$

$${t}_{A} \geq \frac{{t}_{b a t c h}}{{n}_{c r y s}}$$

The mass flow of the centrifuges for the model F_{cf,sm} is:

$${F}_{c f , s m} = \frac{{α}_{c f , f i l l} \cdot {m}_{cf , max}}{100 \cdot {t}_{c}} , {t}_{c} \geq \frac{{t}_{cf , min}}{{n}_{c f}}$$

a_{cf,fill}=Average fill height of active centrifuges [%]
m_{cf,max}=Average maximum capacity of active centrifuges [kg]
t_{c}=Time between centrifuge starts [s]
t_{cf,min}=Minimum batch time of the [-]
n_{cf}=Number of active centrifuges [-]

The controlled variables of the model are the mass inside the feed tank and the strike receivers. The manipulated variables are Fₜⱼ, F_{crys,sm} and F_{cf,sm}. The control scheme of the model is summarized in FIG. 3. To reach the goal of controlling the desired states m_{feedtank,sm} and m_{sr,sm}, the dead time of the crystallisation process and delay caused by the discrete control of ty require the intermediate states F_{crys,delay} and Fₚₜₙ.

The t_{A} time is calculated as

$${t}_{A} = Δ {m}_{crys , max} \cdot \frac{{α}_{c r y s , c o o k} \cdot {b}_{c o o k} - {α}_{c r y s , s e e d} \cdot {b}_{s e e d}}{{b}_{feed} \cdot {F}_{c r ys , sm}}$$

$$s . t . : {F}_{c r y s , s m} \leq {n}_{c r y s} \cdot Δ {m}_{crys , max} \cdot \frac{{α}_{crys , cook} {b}_{c o o k} - {α}_{crys , seed} \cdot {b}_{seed}}{{b}_{feed} \cdot {t}_{b a t c h}}$$

t_{c} can be calculated from this model as:

$${t}_{c} = \frac{{α}_{c f , f i l l} \cdot {m}_{cf , max}}{{F}_{cf , sm}}$$

The model only consists of the states and the manipulated variables as sown in the following table while the other variables are considered as either auxiliary variables, parameters or dis-turbance variables:

| Variable | | | |
|---|---|---|---|
| type | Name | Shape | Comment |
| State (x) | m_{feedtank, sm} | Scalar | Feed tank mass |
| | m_{sr, sm} | Scalar | Total mass in both strike receivers |
| | F_{crys, delay} | Scalar | Delayed F_{crys, sm}, due to t_{A} |
| | Fₚₜₙ | nₚₜₙx1 | Dead time approximation for F_{mc} |
| MV (u) | Fₜⱼ | Scalar | Thick juice flow to the sugar house |
| | F_{crys, sm} | Scalar | Average mass flow through all |
| | | | crystallizers |
| | F_{cf, sm} | Scalar | Mass flow through all centrifuges |

### REFERENCE SIGNS

10 plant section
11 common feed tank
5 12 crystallisers
13 seed crystalliser
14 seed tank
15 strike receivers
16 centrifuges
Fₜⱼ thick juice mass flow rate to the feed tank
F_{crys,sm} feed syrup mass flow rate from the feed tank to all crystallisers
F_{cf,sm} massecuite mass flow rate to all centrifuges

1. A method for controlling a plant section of a sugar production plant comprising a common feed tank and multiple crystallisers and one or more strike receivers and one or more centrifuges,
wherein the multiple crystallisers are configured for receiving feed syrup from the common feed tank and crystallising sugar in a semi-batch process in order to obtain massecuite,
wherein the one or more strike receivers are configured for receiving massecuite discharged from one or more of the crystallisers and to feed the massecuite to one or more of the centrifuges,
wherein the centrifuges are configured for receiving the massecuite and separating syrup from sugar crystals in a batch process,
wherein the method includes the following method steps executed by a control unit, optionally a model predictive control unit:
a) determining a thick juice mass flow rate to the feed tank (Fₜⱼ) and a feed syrup mass flow rate from the feed tank to all crystallisers (Fcrys,sm) and a massecuite mass flow rate to all centrifuges (Fcf, sm) using a continuous substitution model of the plant section,
b) controlling the common feed tank and the multiple crystallisers and the one or more centrifuges depending on the determined thick juice mass flow rate to the feed tank (Fₜⱼ) and the determined feed syrup mass flow rate from the feed tank to all crystallisers (Fcrys,sm) and the determined massecuite mass flow rate to all centrifuges (Fcf, sm).

2. The method according to claim 1, characterized in that method step b) includes controlling starting times of the multiple crystallisers and the one or more centrifuges.

3. The method of claim 1, characterized in that method step b) includes controlling an influx to the common feed tank.

4. The method of claim 1, wherein the method further includes determining a feed tank mass in the common feed tank, wherein method step a) includes obtaining the respective flow rates depending on the determined feed tank mass.

5. The method of claim 1, wherein the method further includes determining an aggregate mass in all of the strike receivers, wherein method step b) includes obtaining the respective flow rates depending on the determined aggregate mass in all of the strike receivers.

6. The method of claim 1, wherein the multiple crystallizers are configured as evaporating crystallisers, optionally vacuum pans, or as cooling crystallisers.

7. The method of claim 1, wherein the control unit determines boundary conditions for step a) depending on a predetermined number of active crystallisers.

8. The method of claim 1, wherein the control unit determines boundary conditions for step a) depending on a predetermined number of active centrifuges.

9. The method of claim 1, wherein the plant section additionally includes at least one seed crystallizer configured for receiving feed syrup from the common feed tank and a seed tank configured to receive seed massecuite from the seed crystallizer and for providing the seed magma to the multiple crystallisers.

10. The method of claim 9, characterized in that step a) further includes determining a feed syrup mass flow rate from the feed tank to the seed crystalliser and a seed magma flow to the multiple crystallisers using the continuous substitution model of the plant section.

11. The method of claim, characterized in that the method further includes determining a seed tank mass in the seed tank, wherein method step a) includes obtaining the respective flow rates depending on the determined seed tank mass.

12. The method of claim 1, wherein the common feed tank and the multiple crystallisers and the one or more strike receivers and the one or more centrifuges form a first production line, wherein the plant section additionally includes a second production line comprising a common feed tank and multiple crystallisers and one more strike receivers and one or more centrifuges, wherein the syrup obtained in the centrifuges of the first production line is fed back to the common feed tank of the second production line.

13. A control unit, optionally a model predictive control unit, for controlling a plant section of a sugar production plant comprising a common feed tank and multiple crystallisers and one or more strike receivers and one or more centrifuges,
wherein the multiple crystallisers are configured for receiving feed syrup from the common feed tank and crystallising sugar in a semi-batch process in order to obtain massecuite,
wherein the one or more strike receivers are configured for receiving massecuite discharged from one or more of the crystallisers and to feed the massecuite to one or more of the centrifuges,
wherein the centrifuges are configured for receiving the massecuite and separating syrup from sugar crystals in a batch process,
wherein the control unit is configured for executing the following method steps:
a) determining a thick juice mass flow rate to the feed tank (Fₜⱼ) and a feed syrup mass flow rate from the feed tank to all crystallisers (Fcrys,sm) and a massecuite mass flow rate to all centrifuges (Fcf, sm) using a continuous substitution model of the plant section,
b) controlling the common feed tank and the multiple crystallisers and the one or more centrifuges depending on the determined thick juice mass flow rate to the feed tank (Fₜⱼ) and the determined feed syrup mass flow rate from the feed tank to all crystallisers (Fcrys,sm) and the determined massecuite mass flow rate to all centrifuges (Fcf, sm).

14. A sugar production plant comprising a common feed tank and multiple crystallisers and one or more strike receivers and one or more centrifuges,
wherein the multiple crystallisers are configured for receiving feed syrup from the common feed tank and crystallising sugar in a semi-batch process in order to obtain massecuite,
wherein the one or more strike receivers are configured for receiving massecuite discharged from one or more of the crystallisers and to feed the massecuite to one or more of the centrifuges,
wherein the centrifuges are configured for receiving the massecuite and separating syrup from sugar crystals in a batch process,
characterized by a control unit according to claim 13.

15. Sugar production plant according to claim 14, characterized in that the common feed tank and the multiple crystallisers and the one or more strike receivers and the one or more centrifuges-form a first production line, wherein the plant section additionally includes a second production line comprising a common feed tank and multiple crystallisers and one more strike receivers and one or more centrifuges, wherein the syrup obtained in the centrifuges of the first production line is fed back to the common feed tank of the second production line.

16. A computer program comprising instructions which, when the computer program is executed by a computer or a control unit, cause the computer or the control unit to carry out the method steps of claim 1.
